(19) United States
(12) Patent Application Publication
(10) Pub. No.: US 2023/0305763 A1
(43) Pub. Date: Sep. 28, 2023

(54) INFORMATION PROCESSING APPARATUS AND RECORDING MEDIUM

(71) Applicant: TOSHIBA TEC KABUSHIKI KAISHA, Tokyo (JP)

(72) Inventor: Fumiharu IWASAKI, Sunto (JP)

(73) Assignee: TOSHIBA TEC KABUSHIKI KAISHA, Tokyo (JP)

(21) Appl. No.: 17/705,067

(22) Filed: Mar. 25, 2022

(51) Int. Cl. G06F 3/12; G06T 7/00; B41J 29/393

(52) U.S. Cl. CPC G06F 3/1208; G06T 7/001; G06F 3/1254; B41J 29/393; G06T 2207/30144

(57) ABSTRACT

An information processing apparatus includes an acquirer, an evaluator, a generator, and an adjustment instruction transmitter. The acquirer acquires an image of a print pattern printed by a printer. The evaluator evaluates a print quality of the printer based on the image of the print pattern acquired by the acquirer. The generator generates a command for adjusting the print quality of the printer based on an evaluation result of the evaluator. The adjustment instruction transmitter transmits the command generated by the generator to the printer.

### FIELD

Embodiments described herein relate generally to an information processing apparatus and a recording medium.

### BACKGROUND

A printer (e.g., a thermal printer) may display a setting screen for accepting a setting input of a print quality and instructing the printer to perform printing based on the accepted setting. Additionally or alternatively, a printer may be instructed to perform printing by using a command supported by the printer itself.

### DESCRIPTION OF THE DRAWINGS

FIG. 1 is a schematic diagram illustrating an example of a print quality setting system, according to some embodiments;

FIG. 2 is a diagram schematically illustrating an example of an internal configuration of a thermal printer, according to some embodiments;

FIG. 3 is a block diagram illustrating an example of a hardware configuration of an information processing apparatus, according to some embodiments;

FIG. 4 is a block diagram illustrating an example of a functional configuration of the information processing apparatus, according to some embodiments;

FIG. 5 is a schematic diagram illustrating an example of a print pattern, according to some embodiments;

FIG. 6 is a schematic diagram illustrating an example of a printing result of the print pattern, according to some embodiments;

FIG. 7 is a schematic diagram illustrating an example of the printing result of the print pattern, according to some embodiments; and

FIG. 8 is a flowchart illustrating an example of a flow of control processing of the information processing apparatus, according to some embodiments.

### DETAILED DESCRIPTION

The operation of setting the print quality of the printer is complicated because re-adjustment is performed while confirming the adjustment result. For these reasons, it is desired to improve the method of setting the print quality of the printer.

In general, according to an embodiment, an information processing apparatus includes an acquirer, an evaluator, a generator, and an adjustment instruction transmitter. The acquirer acquires an image of a print pattern printed by a printer. The evaluator evaluates a print quality of the printer based on the image of the print pattern acquired by the acquirer. The generator generates a command for adjusting the print quality of the printer based on an evaluation result of the evaluator. The adjustment instruction transmitter transmits the command generated by the generator to the printer.

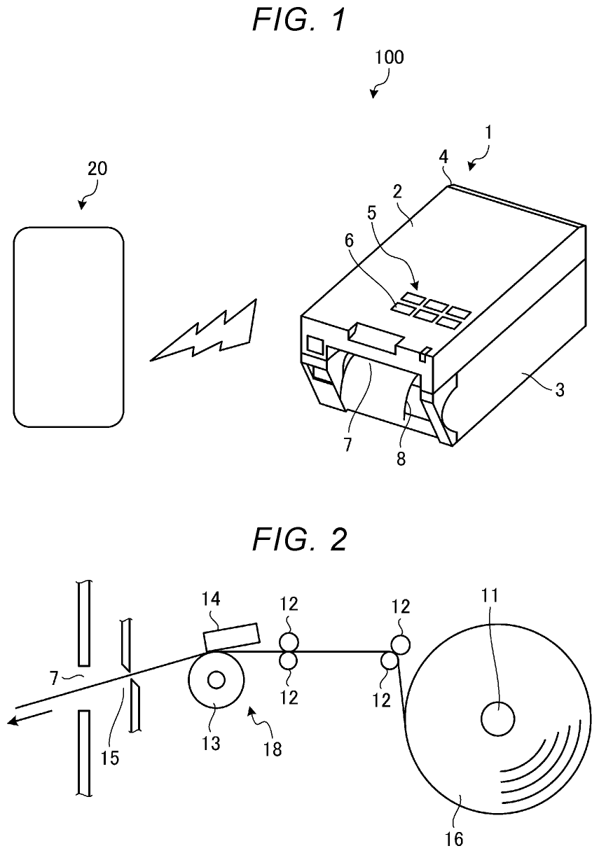

Embodiments of a print setting system of the printer will be described in detail with reference to the accompanying drawings. FIG. 1 is a system configuration diagram of a print setting system 100 of the printer, according to some embodiments. The print setting system 100 includes a thermal printer 1 and an information processing apparatus 20.

The thermal printer 1 is an example of the printer. The thermal printer 1 is connected to a higher-level apparatus (e.g., a POS (Point Of Sales) terminal in the embodiment) (not illustrated) and functions as a receipt printer for receiving transaction information or the like. The transaction information may be print data from the POS terminal. Accordingly, the thermal printer 1 may print a receipt. It is noted that this is an example of a method of using the thermal printer 1, and the method may be used in other fields. For example, the thermal printer may printer other documents (not just receipts) and may receive other information (not just transaction information). In addition, a method of acquiring the print data by the thermal printer 1 is not limited to reception from the higher-level apparatus, and other methods may be used.

The thermal printer 1 includes an upper housing 2 and a lower housing 3. The upper housing 2 is rotatably provided on the lower housing 3 with one end side 4 as an axis. If the upper housing 2 is rotated from a state illustrated in FIG. 1, the thermal printer 1 is opened to reveal an inside (not shown). An operation unit (operator) 5 is provided on an upper surface of the upper housing 2.

The operation unit 5 includes a plurality of operation buttons 6. The operation unit 5 inputs various instructions including the power on and power off to the thermal printer 1. A portion of the operation button 6 includes a light emitting unit (light emitter). The light emitting unit is configured with, for example, a light emitting diode (LED). In addition, the thermal printer 1 has an issuing port 7. The issuing port 7 discharges a printed heat-sensitive paper (hereinafter, also referred to as a printed paper) 8 such as a receipt paper from an inside to an outside of the thermal printer 1. The inside of the thermal printer 1 is described herein with reference to FIG. 2. The outside of the thermal printer 1 is the portion of the thermal printer 1 not contained by the upper housing 2 and the lower housing 3.

The information processing apparatus 20 is an apparatus for setting a print quality of the printer such as a thermal printer 1. The information processing apparatus 20 is connected to the thermal printer 1 and transmits information on the print quality setting of the thermal printer 1. The information processing apparatus 20 may be, for example, a smartphone or a tablet-type PC, but the information processing apparatus is not limited thereto.

Next, an example of an internal structure of the thermal printer 1 according to some embodiments will be described. FIG. 2 is a diagram schematically illustrating an example of the internal structure of the thermal printer 1, according to some embodiments. As illustrated in FIG. 2, the thermal printer 1 includes a holding portion 11, a plurality of guide rollers 12, a platen 13, a thermal head 14, a cutter 15 configured with a pair of blades, and the like.

The holding portion 11 rotatably holds a heat-sensitive paper 16 wound in a roll shape (e.g., a cylindrical shape). The guide roller 12 guides the heat-sensitive paper 16 (e.g., unwinding the heat-sensitive paper 16) from the holding portion 11 between the platen 13 and the thermal head 14. Two pairs of the guide rollers 12 are provided in a conveyance path reaching from the holding portion 11 to a position between the platen 13 and the thermal head 14.

The platen 13 conveys the heat-sensitive paper 16 by rotating a conveying motor as a drive source. The platen 13 conveys the heat-sensitive paper 16 by interposing the heat-sensitive paper 16 together with the thermal head 14. The conveying motor is configured with, for example, a stepping motor. A convey unit 18 (conveyor) for conveying the heat-sensitive paper 16 is configured with the platen 13 and the conveying motor.

The thermal head 14 is a line thermal head in which a plurality of heating elements (hereinafter, also referred to as heaters) are provide on a line along a direction (direction perpendicular to the paper surface in FIG. 2) intersecting (e.g., “being perpendicular to”) a conveyance direction of the heat-sensitive paper 16. In addition, the thermal head 14 is biased toward the platen 13 with a predetermined pressing force. The thermal head 14 heats the above-described heating element and applies heat energy to the heat-sensitive paper 16 to perform printing on the heat-sensitive paper 16 conveyed by the convey unit 18.

The cutter 15 is formed by combining a flat plate-shaped fixed blade and movable blade having the same shape and is able to cut the heat-sensitive paper 16 conveyed by the convey unit 18 at any position by sliding the movable blade against the fixed blade. In FIG. 2, the fixed blade is arranged in the upper portion of the figure, and the movable blade is arranged in the lower portion of the figure. In other embodiments, the fixed blade may be arranged on a lower portion and the moveable blade may be arranged in the upper portion.

The movable blade is driven by a cutter motor to be movable in the vertical direction illustrated in FIG. 2. In some embodiments, the movable blade is located downward and allows the heat-sensitive paper 16 to pass between the movable blade and the fixed blade. If the heat-sensitive paper 16 is to be cut, then the movable blade moves upward. The heat-sensitive paper 16 cut by the cutter 15 is issued from the issuing port 7 as the printed paper 8.

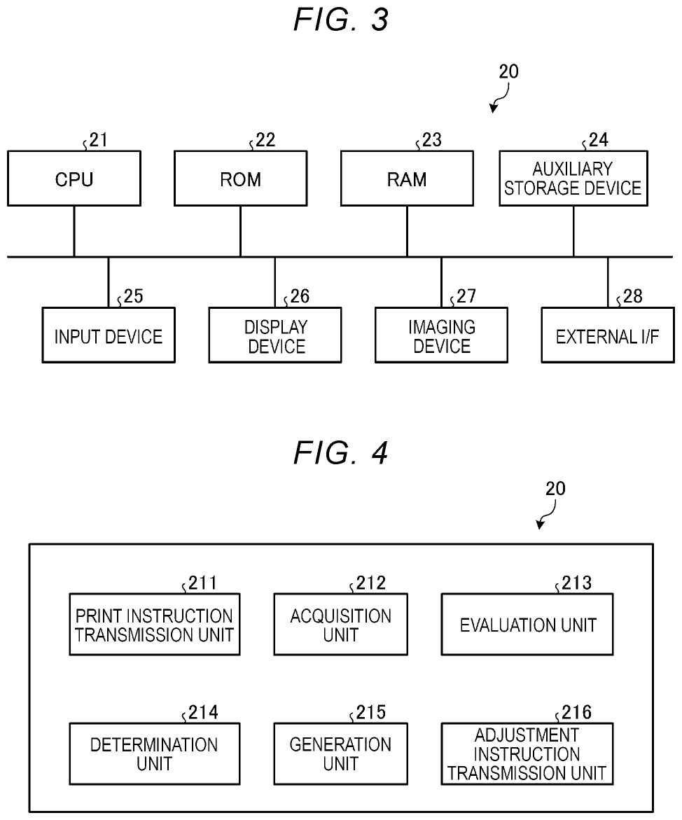

Next, an example of a hardware configuration of the information processing apparatus 20 according to some embodiments will be described. As illustrated in FIG. 3, the information processing apparatus 20 includes a central processing unit (CPU) 21, a read only memory (ROM) 22, a random access memory (RAM) 23 (or other non-transitory processor readable medium), an auxiliary storage device 24, an input device 25, a display device 26, an imaging device 27, and an external interface (I/F) 28.

The CPU 21 is an example of a processor. The CPU 21 is an arithmetic unit that realizes each function of the information processing apparatus 20 by reading programs and data stored in the ROM 22, the auxiliary storage device 24, and the like onto the RAM 23 and executing processing using processor-readable instructions. The RAM 23 is a volatile memory used as a work area or the like of the CPU 21. The ROM 22 is a non-volatile memory.

The auxiliary storage device 24 is, for example, a recording device such as a hard disk drive (HDD) or a solid state drive (SSD) and records, for example, an operating system (OS), an application program, various data, and the like.

The input device 25 is a device for a user using the information processing apparatus 20 to perform various operations. The input device 25 is configured with, for example, a touch panel or a hardware key. The display device 26 is a display device that displays various types of information. The display device 26 is configured with, for example, a liquid crystal display. It is noted that the display device 26 may be integrated with the input device 25, for example, in the form of a touch panel.

The imaging device 27 is an example of an imaging unit. The imaging device 27 is an imaging device having an image sensor such as a charge coupled device (CCD) or a complementary metal oxide semiconductor (CMOS). Under the control of the CPU 21 (e.g., in response to a control signal from the CPU 21), the imaging device 27 images a subject to be imaged to generate an image data (hereinafter, also simply referred to as an image) representing the subject. For example, the imaging device 27 generates an image representing the print pattern by imaging the print pattern. The printer pattern is later printed on the receipt by the printer 1.

The external I/F 28 is a communication interface for connecting the information processing apparatus 20 to the printer 1. The external I/F 28 is, for example, wireless communication such as wireless fidelity (Wi-Fi) and Bluetooth®.

Subsequently, a functional configuration of the information processing apparatus 20 according to the embodiment will be described. FIG. 4 is a block diagram illustrating an example of the functional configuration of the information processing apparatus 20, according to some embodiments. The information processing apparatus 20 functions as a print instruction transmission unit (print instruction transmitter) 211, an acquisition unit (acquirer) 212, an evaluation unit (evaluator) 213, a determination unit (device configured to make one or more determinations) 214, a generation unit (generator) 215, and an adjustment instruction transmission unit (adjustment instruction transmitter) 216 by the CPU 21 operating according to a control program recorded in the ROM 22 or the RAM 23. It is noted that each of the above-mentioned functional configurations may be realized by hardware, and the information processing apparatus 20 may have the above-mentioned functions.

The print instruction transmission unit 211 is an example of the print instruction transmission unit. The print instruction transmission unit 211 transmits a print instruction of a print pattern 40 to the printer 1. In addition, the print instruction transmission unit 211 selects the print pattern according to a type of the printer 1 and transmits the print instruction of the selected print pattern to the printer 1. For example, the print instruction transmission unit 211 transmits the print instruction of the print pattern 40 input by the user to the printer 1 in cooperation with the input device 25.

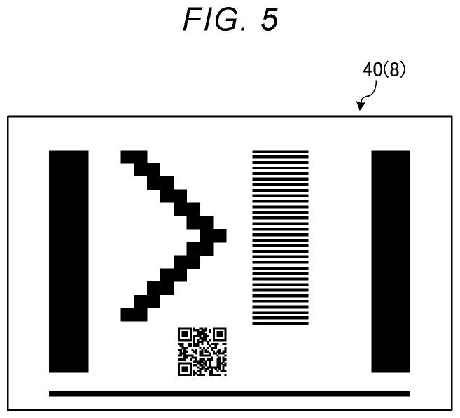

Herein, the print pattern will be described. FIG. 5 is a diagram illustrating an example of the print pattern 40, according to some embodiments. The print pattern 40 is a print data for inspecting or evaluating the print quality of the printer 1. As an example, as illustrated in FIG. 5, the print pattern 40 is configured with various patterns such as a black-painted rectangle, a large symbol, a barcode, a QR Code®, and a thick line. If the printer 1 prints the print pattern 40, blurring, seeping, and the like may appear in the printing result according to the current print settings. In other words, the various patterns of the print pattern 40 can be used to inspect or evaluate the print quality. It is noted that the print pattern 40 is not limited to the example of FIG. 5. For example, it should be appreciated that the printer pattern 40 may be configured with other patterns (e.g., one or more shapes, symbols, barcodes, QR Codes®, lines, and the like).

In this manner, the print instruction transmission unit 211 transmits the print instruction to the target thermal printer 1. Accordingly, the printer 1 prints the print pattern 40 such that the print quality is inspected and/or evaluated.

The description will be made referring back to FIG. 4. The acquisition unit 212 is an example of the acquisition unit. The acquisition unit 212 acquires an image of the print pattern 40 printed by the printer 1 in cooperation with the imaging device 27. For example, if the imaging device 27 detects the printed paper 8, the acquisition unit 212 allows the imaging device 27 to operate, so that imaging of the print pattern 40 printed on the printed paper 8 is started, and the image of the print pattern 40 captured by the imaging device 27 is acquired.

In addition, the acquisition unit 212 acquires the image of the print pattern printed by the printer 1 in response to transmission of the print instruction transmission unit 211. It is noted that the image captured by the imaging device 27 is stored in the auxiliary storage device 24. In addition, the acquisition unit 212 may acquire the image of the print pattern 40 captured by the imaging device 27 from the auxiliary storage device 24.

The evaluation unit 213 is an example of the evaluation unit. The evaluation unit 213 evaluates the print quality of the printer 1 based on the image of the print pattern acquired by the acquisition unit 212. Specifically, the evaluation unit 213 evaluates the print quality of the printer 1 by comparing the image of a reference printing result of the print pattern in the printer 1 with the image of the print pattern acquired by the acquisition unit 212. Herein, it is preferable that the reference printing result is, for example, the print pattern printed with an appropriate print setting value (or print quality).

The evaluation unit 213 compares the image of the reference print pattern corresponding to the printer 1 with the image of the print pattern acquired by the acquisition unit 212, and if the image of the reference print pattern and the acquired image of the print pattern are matched or the degree of matching (for example, the degree of similarity) satisfies a predetermined threshold value, the evaluation unit 213 evaluates that the print quality is in an appropriate state. That is, the print quality is acceptable/satisfactory.

In addition, the evaluation unit 213 compares the image of the reference print pattern corresponding to the printer 1 with the image of the print pattern acquired by the acquisition unit 212 and evaluates that the print quality is inappropriate if the image of the reference print pattern and the acquired image of the print pattern do not match or if the degree of matching (for example, the degree of similarity) is less than a predetermined threshold value.

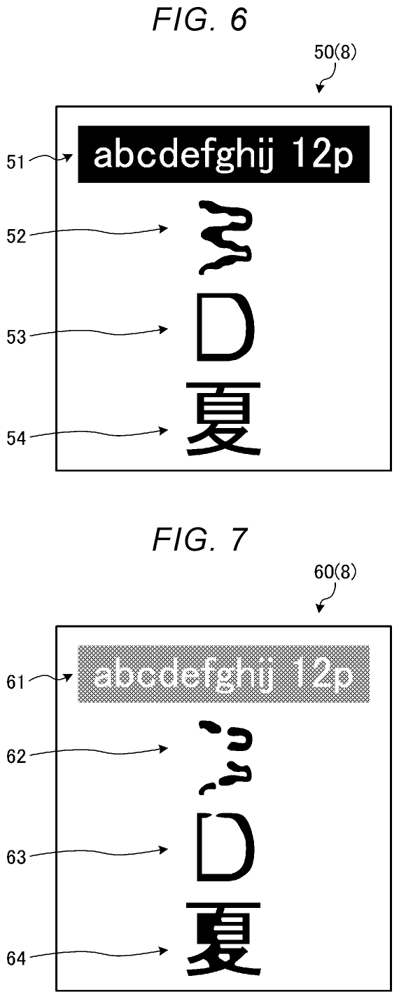

Herein, the operation of the evaluation unit 213 will be described with reference to FIGS. 6 and 7. FIG. 6 is a diagram illustrating an example of a printing result 50 of a print pattern printed with the print setting of the printer 1 that is a reference print setting, according to some embodiments. FIG. 7 is a diagram illustrating an example of a printing result 60 of a print pattern printed in a state where the print setting of the printer 1 is inappropriate, according to some embodiments.

The printing result 50 of the print pattern illustrated in FIG. 6 includes a first pattern 51, a second pattern 52, a third pattern 53, and a fourth pattern 54 as images for inspecting or evaluating the print quality of the printer 1. The first pattern 51, the second pattern 52, the third pattern 53, and the fourth pattern 54 are images of a reference print pattern, that is, the printing result 50 of the print pattern printed with the appropriate print setting value (or print quality). As described herein, the appropriate print setting value (or print quality) is a print setting value (or print quality) that satisfies a predetermined threshold value, indicating that the print quality is satisfactory/acceptable.

As an example, the first pattern 51 is an image in which white characters painted in black (abcdefghij 12p) are clearly printed. That is, the characters are complete and/or there is no smudging/smearing/blurring (or there is a satisfactory/threshold amount of smudging/smearing/blurring). The second pattern 52 is an image in which characters (w in lowercase letters rotated 90 degrees to the left) are printed without blurring. The third pattern 53 is an image printed without missing a character (capital letter D). For example, the third pattern 53 is printed completely without any skips/jumps in the print. The strokes of the third pattern 53 are complete. The fourth pattern 54 is an image printed without seeping the characters (“summer” in Japanese kanji characters). It is noted that the printing result 50 of the reference print pattern is not limited thereto.

In the printing result 60 of the print pattern illustrated in FIG. 7, the first pattern 61, the second pattern 62, the third pattern 63, and the fourth pattern 64 are printed as images for inspecting or evaluating the print quality of the printer 1.

Herein, the first pattern 51 and the first pattern 61, the second pattern 52 and the second pattern 62, the third pattern 53 and the third pattern 63, and the fourth pattern 54 and the fourth pattern 64 represent the same print patterns, respectively. In addition, the printing result 50 of the print pattern illustrated in FIG. 6 is stored as an image data in the auxiliary storage device 24 of the information processing apparatus 20. In addition, it is assumed that the printing result 60 of the print pattern illustrated in FIG. 7 is an image data acquired by the acquisition unit 212.

In this case, the evaluation unit 213 evaluates the print quality of the printer 1 by comparing the printing result 50 of the print pattern of FIG. 6 with the printing result 60 of the print pattern of FIG. 7.

For example, if the first pattern 51 and the first pattern 61 are compared, a print density of the first pattern 61 is lower than that of the first pattern 51. In this case, the evaluation unit 213 evaluates that the first pattern 61 acquired by the acquisition unit 212 is in a state where the print density is lower than that of the first pattern 51. In addition, since the image of the reference print pattern and the image of the acquired print pattern do not match each other, the evaluation unit 213 evaluates that the print quality is inappropriate (e.g., the print quality does not satisfy a predetermined threshold). In some embodiments, the state where the print density is low results from, for example, the state in which the amount of heat of the thermal head 14 of the thermal printer 1 is low (e.g., does not satisfy a threshold).

In addition, for example, if the second pattern 52 and the second pattern 62 are compared, the blurring in the second pattern 62 occurs in a portion of the pattern included in the printed information as compared with the second pattern 52. In this case, the evaluation unit 213 evaluates that the second pattern 62 acquired by the acquisition unit 212 is in a state where the blurring occurs in the print information as compared with the second pattern 52. In addition, the evaluation unit 213 evaluates that the print quality is inappropriate because the image of the reference print pattern and the image of the acquired print pattern do not match (e.g., the print quality does not satisfy a predetermined threshold). In some embodiments, a state in which the blurring occurs in a portion of the characters, results from, for example, the state in which a conveyance speed of the platen 13 of the thermal printer 1 is high (e.g., does not satisfy a threshold).

In addition, for example, if the third pattern 53 and the third pattern 63 are compared, a portion of the characters included in the printed information is missing in the third pattern 63 as compared with the third pattern 53. That is, the strokes of the third pattern 63 are incomplete (e.g., there are gaps, skips, jumps in the third pattern 63). In this case, the evaluation unit 213 evaluates that the third pattern 63 acquired by the acquisition unit 212 is in a state where the missing characters (or strokes) occur in the print information as compared with the third pattern 53. In addition, the evaluation unit 213 evaluates that the print quality is inappropriate since the image of the reference print pattern and the image of the acquired print pattern do not match (e.g., the print quality does not satisfy a predetermined threshold). It is noted that the state in which the missing characters or strokes occurs in a portion of the pattern, results from, for example, the state in which the amount of heat of a portion of the heating element of the thermal head 14 of the thermal printer 1 is low (e.g., does not satisfy a threshold).

In addition, for example, if the fourth pattern 54 and the fourth pattern 64 are compared, the seeping occurs in the fourth pattern 64 in a portion of the characters included in the printed information as compared with the fourth pattern 54. That is, the character of the third pattern 64 is blurred/seeping. In this case, the evaluation unit 213 evaluates that the fourth pattern 64 acquired by the acquisition unit 212 is in a state where the seeping occurs in the print information as compared with the fourth pattern 54. In addition, the evaluation unit 213 evaluates that the print quality is in an inappropriate state since the image of the reference print pattern and the image of the acquired print pattern do not match (e.g., the print quality does not satisfy a predetermined threshold). It is noted that the state in which the seeping occurs in a portion of the characters, results from, for example, the state in which the amount of heat of a portion of the heating element of the thermal head 14 of the thermal printer 1 is high (e.g., does not satisfy a threshold).

In this manner, the evaluation unit 213 can evaluate the current print quality state of the thermal printer 1 by comparing the printing result 50 of the print pattern with the reference print setting with the printing result 60 of the print pattern printed with the current print setting.

It is noted that, with respect to the timing of evaluation by the evaluation unit 213, the print quality of the print pattern acquired by the acquisition unit 212 may be evaluated individually, or the print quality of the print pattern acquired by the acquisition unit 212 may be evaluated collectively. The timing of evaluation by the evaluation unit 213 is not limited thereto.

The description will be made referring back to FIG. 4. The determination unit 214 is an example of the determination unit. The determination unit 214 determines whether or not to change the print quality setting value of the thermal printer 1 based on the print quality evaluated by the evaluation unit 213. Specifically, if the print quality evaluated by the evaluation unit 213 is in an inappropriate state (e.g., does not satisfy one or more print quality thresholds), the determination unit 214 determines to change the print quality setting value of the thermal printer 1. If the print quality evaluated by the evaluation unit 213 is in an appropriate state (e.g., does satisfy one or more print quality thresholds), the determination unit 214 determines not to change the print quality setting value of the thermal printer 1. It is noted that the function of the determination unit 214 may be possessed by the evaluation unit 213 or the generation unit 215 described later.

The generation unit 215 is an example of the generation unit. The generation unit 215 generates a command for adjusting the print quality of the printer 1 based on the evaluation result of the evaluation unit 213. The generation unit 215 adjusts the print quality of the printer 1 so that the print pattern 40 printed by the printer 1 becomes a reference printing result. Specifically, the generation unit 215 generates a command for changing the print setting if the determination unit 214 determines to change the print quality setting value.

Herein, a command (also referred to as a print setting command) will be described. The command is one of the commonly used printer control commands. The command is a command corresponding to the above-mentioned print quality and includes, for example, a command related to the conveyance speed of the platen 13, a command related to the amount of heat of the thermal head 14, and the like. It is noted that the command is not limited thereto.

For example, if the print density of the print quality evaluated by the evaluation unit 213 is low (e.g., does not satisfy a threshold), and the determination unit 214 determines to change the print setting value, then the generation unit 215 generates a command for changing the print quality setting value so that the print density is high (e.g., satisfies the threshold). As an example, the generation unit 215 generates a setting (control) of the thermal printer 1 so as to increase (or otherwise adjust) the amount of heat of the thermal head 14 if the print density is low.

In addition, for example, if the blurring occurs in the print information of the print quality evaluated by the evaluation unit 213, and the determination unit 214 determines to change the print quality setting value, then the generation unit 215 generates a command for changing the print quality setting value so that the blurring does not occur. As an example, the generation unit 215 generates the setting (control) of the thermal printer 1 so as to decrease (or otherwise adjust) the conveyance speed of the platen 13.

In addition, for example, if the print information of the print quality evaluated by the evaluation unit 213 is missing characters/strokes, and the determination unit 214 determines to change the print quality setting value, then the generation unit 215 generates a command for changing the print quality setting value so that the missing characters/strokes do not occur. As an example, if the missing characters/strokes occur, then the generation unit 215 generates a setting (control) of the thermal printer 1 so as to increase (or otherwise adjust) the amount of heat of the heating element of the thermal head 14 at the missing character/stroke location (e.g., a location corresponding to the print pattern)

In addition, for example, if the seeping occurs in the print information of the print quality evaluated by the evaluation unit 213, and the determination unit 214 determines to change the print quality setting value, then the generation unit 215 generates a command for changing the print quality setting value so that the seeping does not occur. As an example, if the seeping occurs, the generation unit 215 generates a setting (control) of the thermal printer 1 so as to decrease (or otherwise adjust) the amount of heat of the heating element of the thermal head 14 at the seeping location. It is noted that the print quality setting value generated by the generation unit 215 is not limited thereto.

The adjustment instruction transmission unit 216 is an example of the adjustment instruction transmission unit. The adjustment instruction transmission unit 216 transmits the command generated by the generation unit 215 to the printer 1. Specifically, the adjustment instruction transmission unit 216 transmits a command corresponding to the information in which the generation unit 215 changes the print quality setting value according to the evaluation result of the evaluation unit 213 to the printer 1.

In this manner, by transmitting the reference print quality setting value to the target printer 1 by the adjustment instruction transmission unit 216, the user can review the reference print quality setting value on the printer 1 when the print quality setting value is not satisfactory/acceptable. It is noted that the function of the adjustment instruction transmission unit 216 may be possessed by the evaluation unit 213 or the generation unit 215 described later.

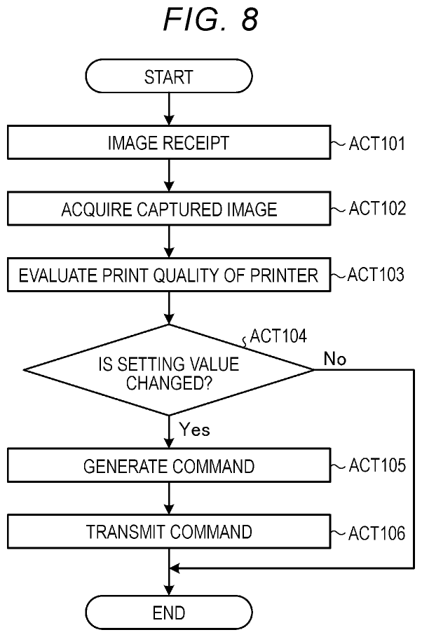

Next, an operation example of the information processing apparatus 20 will be described. FIG. 8 is a flowchart illustrating an example of processing executed by the information processing apparatus 20, according to some embodiments. It is assumed that, for example, after the print instruction transmission unit 211 instructs the printer 1 to print the print pattern, the printer 1 prints the print pattern 40. Subsequently, the processing of the flowchart of FIG. 8 is started.

First, the imaging device 27 images the printed paper 8 on which the print pattern is represented, which is printed by the printer 1 (ACT 101). Herein, the imaging device 27 may perform the imaging according to the user operation or may perform the imaging according to the control of the acquisition unit 212 described above.

Subsequently, the acquisition unit 212 acquires an image of the print pattern captured by the imaging device 27 (ACT 102).

Subsequently, the evaluation unit 213 evaluates the print quality of the printer 1 based on the image of the print pattern acquired by the acquisition unit 212 (ACT 103). Specifically, the evaluation unit 213 evaluates whether the print quality of the printer 1 is appropriate based on a comparison result between the image of the print pattern acquired by the acquisition unit 212 and the image of the reference print pattern.

Subsequently, the determination unit 214 determines whether to change the print setting value based on the evaluation result of the evaluation unit 213 (ACT 104). Herein, if the print quality evaluated by the evaluation unit 213 is in an appropriate state (e.g., the image of the print pattern acquired by the acquisition unit 212 and the image of the reference print pattern match or match within a predetermined threshold value), the determination unit 214 determines not to change the print setting value (No in ACT 104), and the process ends.

On the other hand, if the print quality evaluated by the evaluation unit 213 is in an inappropriate state (e.g., the image of the print pattern acquired by the acquisition unit 212 and the image of the reference print pattern do not match or do not match within a predetermined threshold value), the determination unit 214 determines to change the print setting value (Yes in ACT 104), and the process proceeds to ACT 105.

If the determination unit 214 determines to change the print setting value (Yes in ACT 104), the generation unit 215 generates the command for adjusting the print quality of the printer 1 based on the evaluation result of the evaluation unit 213 (ACT 105).

Subsequently, the adjustment instruction transmission unit 216 transmits the command generated by the generation unit 215 to the printer 1 (ACT 106). If the transmission process is completed, the process ends.

As described above, the information processing apparatus 20 according to the embodiment acquires the printing result of the print pattern printed by the printer 1 and evaluates the print quality of the printer 1 from the printing result. In addition, the information processing apparatus 20 transmits a print setting command corresponding to the changed contents of the print setting according to the evaluation result to the printer 1.

Accordingly, with respect to the operation of performing the print setting of the printer 1, the setting work time can be shortened, and the setting work can be simplified. Therefore, the user can easily perform the print setting of the printer 1.

It is noted that the above-described embodiment can be appropriately modified and performed by changing a portion of the configuration or function of the above-mentioned apparatus. Therefore, in the following description, some modified examples according to the above-described embodiment will be described as other embodiments. It is noted that, in the following description, points different from the above-described embodiment will be mainly described, and detailed description of points common to the contents already described will be omitted. In addition, the modified examples described below may be performed individually or in combination as appropriate.

### Modified Example 1

In the above-described embodiments, the generation unit 215 generates the command for adjusting the print quality of the printer 1 so that the print pattern 40 printed by the printer 1 becomes a reference printing result, but the embodiments above are not limited thereto.

For example, the generation unit 215 may generate a command based on the information set by the user according to user's preference. User preference information may include a user preference to set an edge enhancement process for emphasizing a change point of printed characters, figures, images, or the like for the purpose of allowing a printed line-drawing portion to be easier to see. In this case, the generation unit 215 may generate the command for adjusting the print quality of the printer 1 based on an adjustment method such as edge enhancement set by the user.

It is noted that the generation unit 215 may be configured to allow information regarding the adjustment method to be displayed on a displayed device 26. The adjustment method may be selected (or otherwise interacted with) using a user selection received by the display device 26 via a selection screen. In this case, the generation unit 215 generates the command for adjusting the print quality of the printer 1 based on the adjustment method selected from the selection screen. Examples of the adjustment method include bolding in addition to the above-mentioned edge enhancement.

### Modified Example 2

In the above-described embodiments, the thermal printer has been described as an example of the printer 1, but the printer 1 is not limited thereto. For example, the embodiments may apply to a printer having a printing method other than the thermal printer.

### Modified Example 3

In addition, in the above-described embodiments, the printer 1 that performs printing on the heat-sensitive paper such as a receipt paper has been described as an example of the printer 1, but the printer 1 is not limited thereto. For example, the printer 1 may be a printer that performs printing on a paper (for example, a label paper) other than receipt paper.

### Modified Example 4

In the above-described embodiments, the information processing apparatus 20 transmits the print instruction of the print pattern 40 to the printer 1, but the embodiments are not limited thereto. For example, the user may instruct the printer 1 to print the print pattern 40 via the operation unit 5 of the printer 1. In addition, another apparatus other than the information processing apparatus 20 may transmit the print instruction of the print pattern 40 to the printer 1.

### Modified Example 5

In addition, in the above-described embodiments, the acquisition unit 212 acquires the image of the print pattern 40 captured by the imaging device 27, but the embodiments above are not limited thereto. For example, the acquisition unit 212 may acquire the image of the print pattern 40 printed by the printer 1 from the auxiliary storage device 24, another storage device, or the like.

It is noted that, in the above-described embodiments, the control program executed by the information processing apparatus 20 may be configured to be recorded and provided on a computer-readable recording medium such as a CD-ROM. In addition, the control program executed by the information processing apparatus 20 according to the above-described embodiments may be configured to be stored on a computer connected to a network such as the Internet and provided to the apparatus 20 by downloading the control program via the network.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus comprising:
an imaging device;
a wireless communication interface configured to communicate with a printer;
a processor configured to:
acquire, from the imaging device, an image of a print pattern printed by the printer, the image having been imaged by the imaging device;
evaluate a print quality of the printer based on a comparison between an image of a reference printing result of the print pattern in the printer and the image of the print pattern that is acquired;
generate a command for adjusting the print quality of the printer based on an evaluation result; and
transmit the command that is generated to the printer through the wireless communication interface.

2. (canceled)

3. The apparatus according to claim 1, wherein the processor adjusts the print quality of the printer so that the print pattern printed by the printer matches the reference printing result.

4. The apparatus according to claim 1, further comprising a print instruction transmitter configured to transmit a print instruction of the print pattern to the printer,
wherein the processor acquires the image of the print pattern printed by the printer in response to transmission by the print instruction transmitter.

5. The apparatus according to claim 4, wherein the print instruction transmitter selects the print pattern according to a type of the printer and transmits the print instruction of the selected print pattern to the printer.

6. The apparatus according to claim 1, wherein the printer is configured to sandwich a paper between a thermal head and a platen, print the print pattern on the paper using heat of the thermal head, and convey the paper by rotation of the platen, and the command adjusts a print density by adjusting an amount of the heat of the thermal head.

7. The apparatus according to claim 6, wherein the command adjusts the amount of the heat of the thermal head at a particular location corresponding to the print pattern.

8. The apparatus according to claim 1, wherein the printer is configured to sandwich a paper between a thermal head and a platen, print the print pattern on the paper using heat of the thermal head, and convey the paper by rotation of the platen, and the command adjusts a conveyance speed of the platen.

9. A non-transitory processor-readable medium containing processor-readable instructions that, when executed by one or more processors, cause the one or more processors to perform operations comprising:
acquiring, from an imaging device, an image of a print pattern printed by a printer, the image having been imaged by the imaging device;
evaluating a print quality of the printer based on a comparison between an image of a reference printing result of the print pattern in the printer and the acquired image of the print pattern;
generating a command for adjusting the print quality of the printer based on an evaluation result; and
transmitting the command to the printer through a wireless communication interface.

10. (canceled)

11. The non-transitory processor-readable medium according to claim 9, wherein the command for adjusting the print quality of the printer is based on matching the print pattern printed by the printer to the reference printing result.

12. The non-transitory processor-readable medium according to claim 9, the operations further comprising:
transmitting a print instruction of the print pattern to the printer,
wherein the acquired image of the print pattern is printed by the printer in response to the transmission of the print instruction.

13. The non-transitory processor-readable medium according to claim 12, the operations further comprising: selecting the print pattern according to a type of the printer and transmitting the print instruction of the selected print pattern to the printer.

14. The non-transitory processor-readable medium according to claim 9, wherein the printer is configured to sandwich a paper between a thermal head and a platen, print the print pattern on the paper using heat of the thermal head, and convey the paper by rotation of the platen, and the command adjusts a print density by adjusting an amount of the heat of the thermal head.

15. The non-transitory processor-readable medium according to claim 9, wherein the printer sandwiches a paper between a thermal head and a platen, prints the print pattern on the paper using heat of the thermal head, and conveys the paper by rotation of the platen, and the command adjusts an amount of the heat of the thermal head at a particular location corresponding to the print pattern.

16. The non-transitory processor-readable medium according to claim 9, wherein the printer sandwiches a paper between a thermal head and a platen, prints the print pattern on the paper using heat of the thermal head, and conveys the paper by rotation of the platen, and the command adjusts a conveyance speed of the platen.

17. The information processing apparatus of claim 1, wherein the image of the reference printing result of the print pattern is an image of the print pattern that is confirmed to have an appropriate print quality.

18. The non-transitory processor-readable medium of claim 9, wherein the image of the reference printing result of the print pattern is an image of the print pattern that is confirmed to have an appropriate print quality.

19. A method for setting a print quality of a printer, the method comprising:
printing, by the printer, a print pattern on a paper;
imaging, by the printer, the paper to generate an image of the print pattern;
evaluating the print quality of the printer based on a comparison between an image of a reference printing result of the print pattern in the printer and the image of the print pattern;
generating a command for adjusting the print quality of the printer based on the evaluation of the print quality;
transmitting the command to the printer through a wireless communication interface; and
adjusting the print quality of the printer based on the command.

20. The method of claim 19, wherein the image of the reference printing result of the print pattern is an image of the print pattern that is confirmed to have an appropriate print quality.
